(19) United States
(12) Patent Application Publication
(10) Pub. No.: US 2008/0283748 A1
(43) Pub. Date: Nov. 20, 2008

(54) Electron microscope

(75) Inventors: Takao Matsumoto, Iruma (JP); Ruriko Tsuneta, Fuchu (JP); Masanari Koguchi, Kunitachi (JP)

Correspondence Address: Stanley P. Fisher;Reed Smith LLP, Suite 1400, 3110 Fairview Park Drive, Falls Church, VA, 22042-4503, US

(73) Assignee: Hitachi High-Technologies Corporation

(21) Appl. No.: 12/003,374

(22) Filed: Dec. 21, 2007

(30) Foreign Application Priority Data
Jan. 15, 2007 (JP) 2007-006162

(51) Int. Cl. G21K 7/00

(52) U.S. Cl. 250/311

(57) ABSTRACT

An electron microscope for simultaneously adjusting the tilt, rotation and temperature of the specimen, and rapidly heating a desired localized section of the specimen. Specimen holders support the specimen on one side, and contain a space on the other side. A laser beam mechanism for heating the vicinity of the specimen irradiates a focused laser beam onto the specimen from this space. The output from a light position sensor installed in the specimen holders is utilized to adjust the irradiation position of the focused laser beam by controlling a fine motion mechanism for inputting light into the vicinity of the specimen stand.

### CLAIM OF PRIORITY

The present application claims priority from Japanese application JP 2007-006162 filed on Jan. 15, 2007, the content of which is hereby incorporated by reference into this application.

### FIELD OF THE INVENTION

The present invention relates to an electron microscope for irradiating or scanning an electron beam onto a specimen, detecting the electron beam transmitted through the specimen and imaging the specimen.

### BACKGROUND OF THE INVENTION

In recent years, spatial resolution of material to the nanometer level and evaluation of the material elements and structure has become crucial for improving the properties of materials used in a diverse range of devices and state of the art equipment. The transmission electron microscope (TEM) is one evaluation technology for irradiating an accelerated electron beam onto a thin-filmed specimen and imaging the tiny structure of the specimen with high spatial resolution down to the sub-nanometer level. The TEM images the elements contained in the specimen by detecting the X-rays emitted from the specimen after irradiating it with an electron beam and by the energy loss of the electron beam.

Demands are also increasing for a means to evaluate the structure, structural elements, and temperature characteristics of the electromagnetic properties of these types of material. Moreover, an evaluation of material properties that work by heating localized sections of the material can yield important information through knowledge of the material properties. In the case of dielectric materials for example, a section of that material is heated until its dielectric properties are lost, the heating is then stopped, the process of cooling the material to recover the dielectric properties, is greatly dependent on the interaction with the heated section. Observation of this process may yield important information about this interaction. In order to observe these types of interactions, a localized part of the specimen must be quickly heated.

To meet these demands, the technology of the related art utilizes a compact heater built into the specimen mesh of the specimen holder on the electron microscope. In this technique the specimen making contact with the heater is heated by thermal conduction (JP 07 (1995)-147151 A).

During observation, the specimen must also be tilted and rotated. An omnidirectional specimen holder is known in the related art for adjusting the rotation and the tilt of the specimen (JP 10 (1998)-111223 A). However the structure of this omnidirectional specimen holder is of course complicated. Moreover, incorporating the above described heater mechanism into this omnidirectional specimen holder is not an easy task. Usually, the higher the spatial resolution that is needed, the less the space available for specimen in the objective lens section of the electron microscope and must fit into a space of only a few millimeters.

On the other hand, instead of the above described thermal conductive heating, a specimen holder for the transmission electron microscope is also disclosed in the related art for heating the specimen by irradiating it with a laser beam (JP 08 (1996)-31361 A).

### SUMMARY OF THE INVENTION

The specimen holder of the related art utilized with a laser beam requires a large space in the specimen mounting section of the specimen holder for inserting a mirror on the upper section of the specimen mounting section. This type of space generally makes it difficult to obtain a high spatial resolution because the gap versus the objective lens becomes larger. Moreover this method of the related art utilizing a laser beam, affects the focus since the light moves in the same direction as the electron beam. Further, in order to heat a localized section, position alignment to the section for heating is required but nothing is disclosed regarding a mechanism to make this position alignment.

The present invention has the object of providing an electron microscope capable of aligning the position of the specimen section for heating while maintaining high resolution, and utilizing a laser to heat a localized section of the specimen.

In order to achieve the above object, the present invention provides an electron microscope for irradiating or scanning an electron beam onto the specimen and detecting and imaging the electron beam transmitted through the specimen, and that includes: a specimen holder for supporting a specimen and a specimen stand for holding the specimen on one side surface, and containing a space on the other side surface and, a focus light ray unit for heating the specimen or the specimen stand by focusing rays beamed in the vicinity of that side surface.

Further, the present invention provides a transmission electron microscope for irradiating or scanning an electron beam onto the specimen and detecting and imaging the electron beam transmitted through the specimen, and that includes: a specimen piece holder for gripping the specimen stand for holding the specimen on one side and, a focus light ray unit for heating the specimen by focusing rays beamed from the vicinity of that side surface of the specimen stand supported by the specimen piece holder, and a light position sensor formed on the side surface of one side of the specimen piece holder and, a fine positioning mechanism for adjusting the beam position of the light ray onto the specimen by utilizing the output from the light position sensor.

In other words, in the present invention, the specimen holder capable of joint use with a TEM/STEM (scanning-transmission electron microscope) observation device and FIB (focused ion beam) machining device, supports the specimen on one side surface, and on the other side surface focuses and guides the light onto the specimen or the specimen stand, and heats that localized section. Laser light offers a higher intensity as the irradiated light and is transmitted by a tiny optical fiber. Moreover laser light also offers the advantage that a lens can easily be built into the tip of the optical fiber. Heating the specimen in a localized section allow heating just the section desired for observation so that temperature can be swiftly raised and the time resolution of the observation improved.

To align the position of the heated section with the observation section, a light position sensor is prepared below the specimen support section of the specimen holder and light is precision-adjusted onto the center of the light position sensor. If processing the material with an FIB machining device then the distance between the specimen and light position sensor can be preciselymeasuredin advance. Shiftingthelight beam just by a pre-measured distance from the center of the light position sensor allows localized heating of an optional position on the specimen.

The present invention is capable of simultaneously adjusting the tilt, rotation, and temperature regardless of restrictions such as the shape of the specimen. This invention can also heat a desired localized section on the specimen. Moreover, this invention can swiftly raise the temperature in the desired section for observation.

### BRIEF DESCRIPTION OF THE DRAWINGS

FIG. 1 is a pictorial diagram for describing specimen observation by transmission electron microscope in the first embodiment of this invention;

FIG. 2A is a pictorial diagram for describing the method for heating the tip of the specimen holder inside the specimen chamber in the first embodiment;

FIG. 2B is another pictorial diagram for describing the method for heating the tip of the specimen holder inside the specimen chamber in the first embodiment;

FIG. 2C is still another pictorial diagram for describing the method for heating the tip of the specimen holder inside the specimen chamber in the first embodiment;

FIG. 3A is a drawing for describing the procedure for aligning the position of the light spot utilized for heating in the first embodiment;

FIG. 3B is another drawing for describing the procedure for aligning the position of the light spot utilized for heating in the first embodiment;

FIG. 4 is a drawing for describing the procedure for aligning the position of the light spot utilized for heating in the first embodiment;

FIG. 5A is a drawing describing conversion to a signal required for outputting and positioning the output of the four-segment light position utilized in aligning the position of the light spot;

FIG. 5B is a drawing showing signal conversion required for positioning, and the output of the four-segment position utilized in aligning the position of the light spot;

FIG. 6 is drawings showing the screen operation for aligning the position of the light spot among observation procedures in the first embodiment;

FIG. 7 is a flow chart for describing the observation procedure in the first embodiment;

FIG. 8A is a pictorial diagram for describing the method for heating the specimen in the tip of the specimen holder within the specimen chamber in the second embodiment;

FIG. 8B is another pictorial diagram for describing the method for heating the specimen in the tip of the specimen holder within the specimen chamber in the second embodiment; and

FIG. 9 is a pictorial diagram for describing the method for input to the optical fiber in each embodiment of this invention.

### DETAILED DESCRIPTION OF THE PREFERRED EMBODIMENTS

The embodiments of the present invention are described next while referring to the drawings.

### First Embodiment

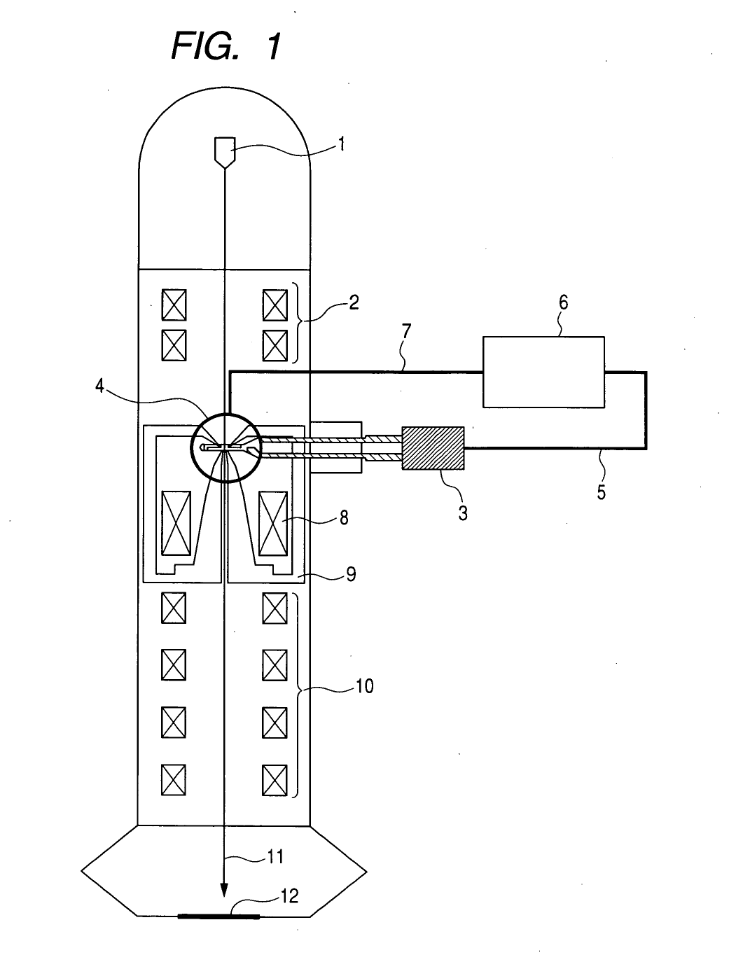

FIG. 1 is a drawing showing the structure of the transmission electron microscope of the first embodiment of this invention, and in particular illustrates observation of the specimen in particular by transmission electron microscope. An electron beam 11 from an electron source 1 is first of all irradiated via a condenser lens 2 onto a specimen placed in the specimen chamber of the electron microscope by way of a specimen holder 3. Electrical current flowing in an objective lens coil 8 and excites a magnetic field formed in the vicinity of the specimen via a magnetic path 9. The specimen is placed in this strong magnetic field and the light focused by a lens. A condenser lens 10 enlarges an image of the specimen connected via the objective lens. A fluorescent panel 12 focuses the image for observation. This embodiment is characterized in including a control device 6, a beam adjuster signal line 7, and an output signal line 5 from the light position sensor built into the specimen holder 3, and a beam mechanism 4 as described in detail later on.

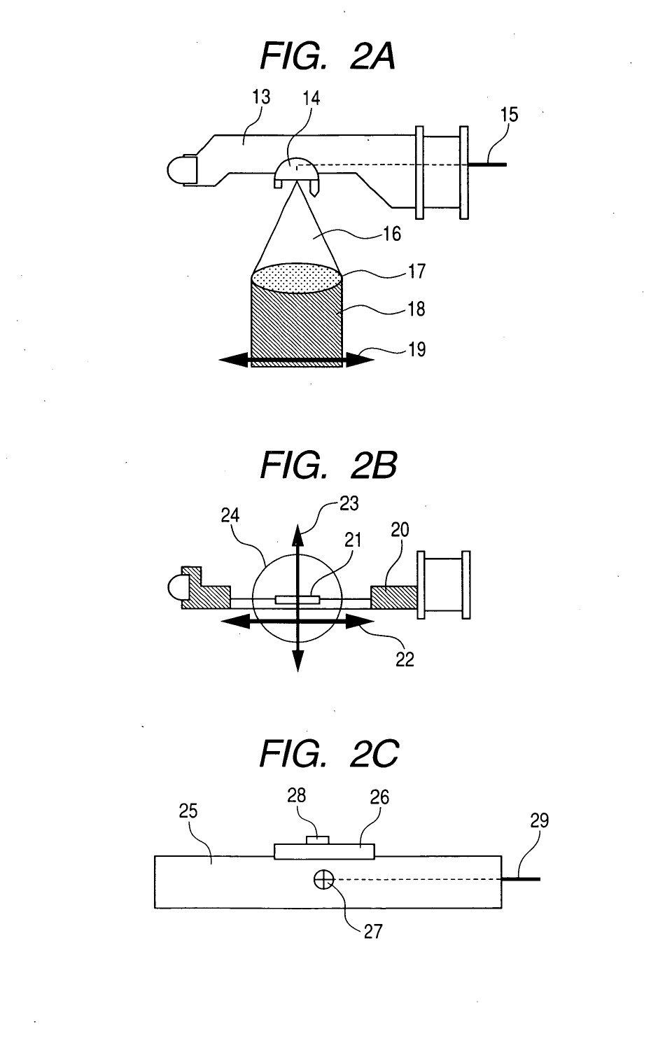

FIG. 2 is enlarged pictorial diagrams of the tip of the specimen holder placed in the specimen chamber of the transmission electron microscope shown in FIG. 1. The first embodiment of this invention is described next in detail while referring to FIG. 2. The specimen holder 13 is a specimen holder capable of being utilized in both a TEM/STEM observation device and an FIB machining device. The specimen holder 13 is structured to hold the specimen on one side, and contains a space on the other side. (Please refer to JP 2006-156263 A for the structure of this type of specimen holder and related information.) In this embodiment, the light irradiates onto the specimen from the side not supporting the specimen. Light is input to the specimen from the tip of a tiny optical fiber where the convergence lens is affixed.

FIG. 2A is a view as seen from above, of the specimen holder 13, the optical fiber 18, the lens 17, and the mesh 14 functioning as the specimen stand. This figure is viewed along the direction that the electron beam progresses. FIG. 2B on the other hand, shows the specimen holder 20 and the mesh 21 as seen from the side. Here, only the outline of the cross section 24 for the lens and optical fiber is shown. The light irradiates onto the specimen from a direction perpendicular to the electron beam. The problem here is how to adjust the converged light to irradiate onto the desired position on the specimen. Making this adjustment requires a mechanism for making fine adjustments to move the position of optical fiber 18 to the vertical direction 23 and the horizontal directions 19 and 22, and pre-placing the mechanism in the holder supporting the optical fiber 18. This fine positioning mechanism can be automatically adjusted by electronic signal control as described below. Of course, a mechanism that is manually adjusted may also be used.

FIG. 2C is an enlarged view of the specimen holder and mesh of FIG. 2B as seen from the side. A light position sensor 27 capable of detecting light is installed below the specimen 28 mountedon the mesh 26 on specimen holder 25. A semiconductor light position sensor may be utilized here. A four-segment type device will prove convenient as the light position sensor but a 2-dimensional array sensor may be used. The output signal lines 15 and 29 from the light position sensor are utilized for adjusting the light beam mechanism as described later.

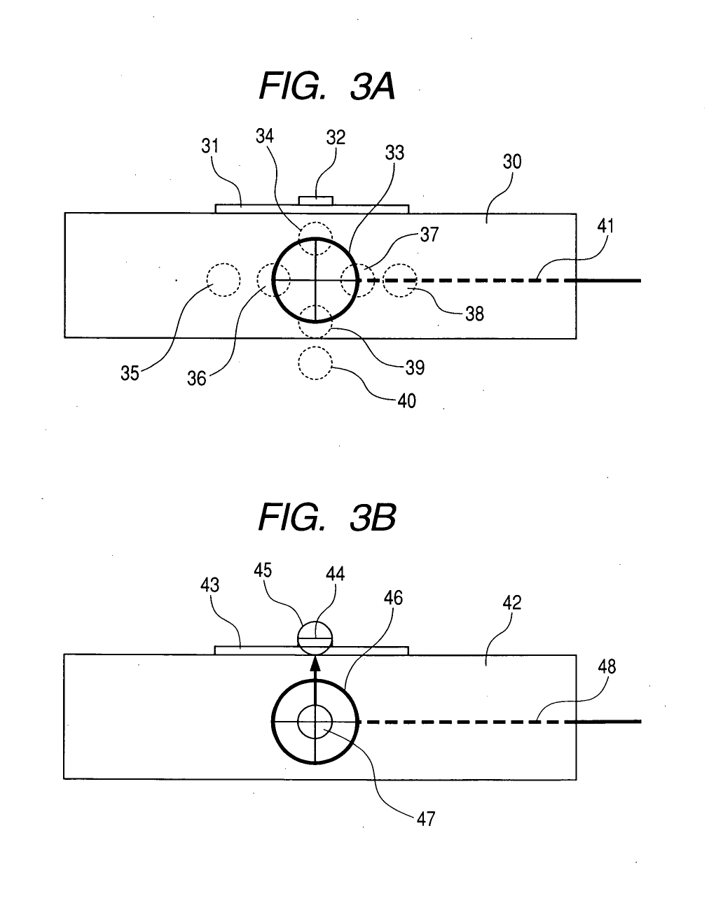

FIG. 3 is for describing in detail the method for adjusting the light spot position by utilizing the fine positioning mechanism and the four-segment light position sensor. The light spot position where light is input from outside the vacuum is designed in advance to be below the mesh 31 and the specimen 32 where the specimen on the holder 30 is positioned. Prior to adjustment, the light spot is at positions such as 34, 35, 36, 37, 38, 39 or 40 in FIG. 3A, but adjustment by the optical fiber fine positioning mechanism utilizes the output signal line 41 from the light position sensor 33 to adjust the light to irradiate onto the light position sensor 33. After verifying the output from the light position sensor 33, adjustment is continuously adjusted based on the signal 41 output from light position sensor 33 so that the light is centered on the light position sensor 33. Needless to say, a mechanism for making coarse adjustments and a mechanism for making fine adjustments can both be provided to make the adjustment easy. After the task of adjusting the light spot position to the center of the light position sensor has been completed, the relative positions of the specimen holder 42, mesh 43, specimen 44, light position sensor 46, and the light spot 47 are as shown in FIG. 3B. A light spot 45 can be irradiated onto the desired position of the specimen 44 by measuring in advance the distance from a position where the specimen is positioned, to the center of the light position sensor 46, and then shifting the light spot position just by that distance. The specimen holder assumed for use in this embodiment can be jointly used by the TEM/STEM observation device as well as the FIB machining device so that FIB machining to make the specimen thinner, the distance between the light position sensor and the thin film processing section on the specimen can be precisely measured.

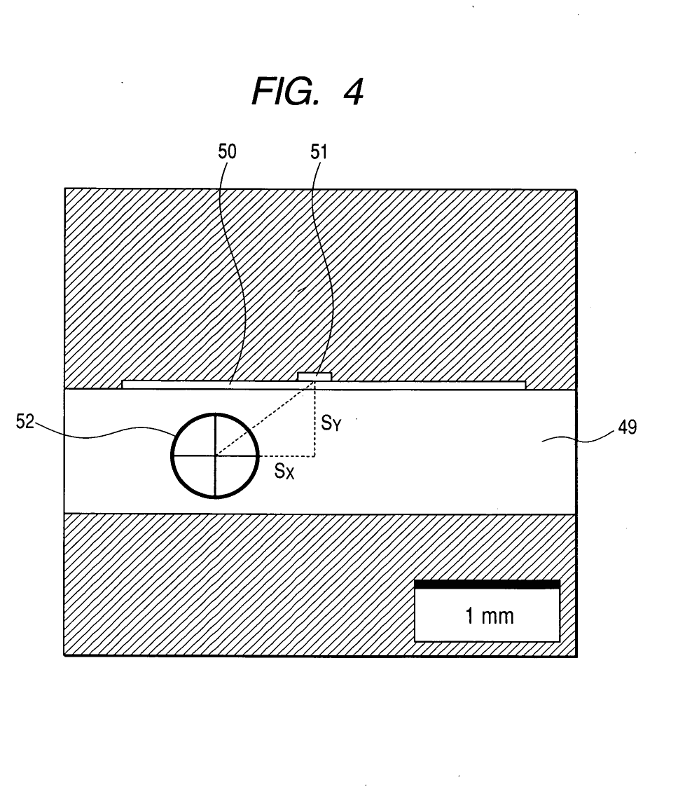

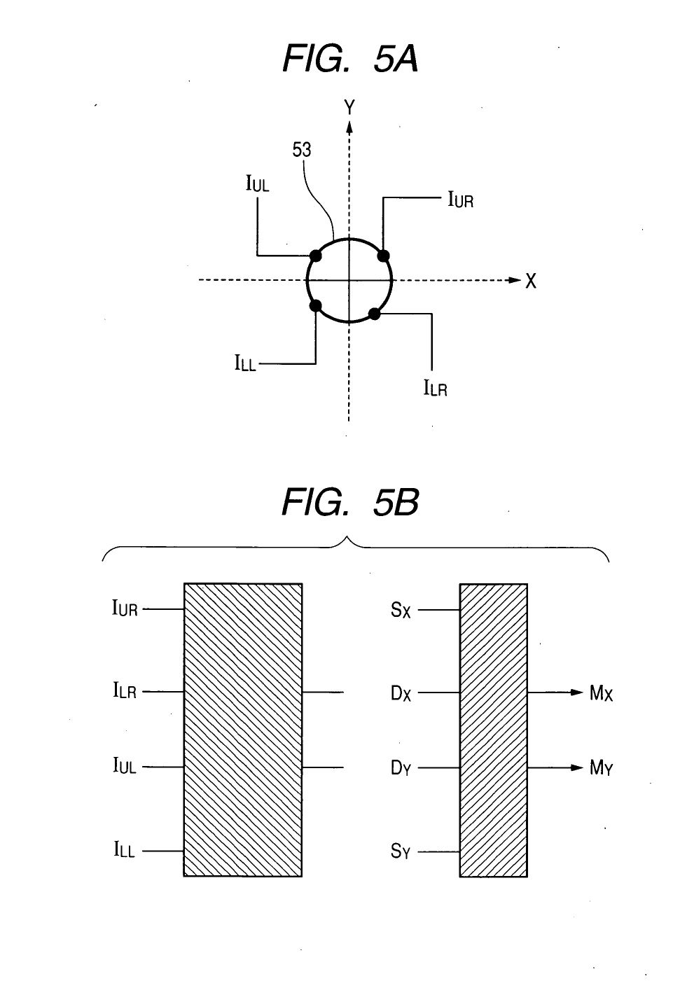

FIG. 4 for example shows an observation screen during FIB machining. When the magnification scale has been increased several hundred times, the specimen holder 49, mesh 50, specimen 51 and the entire light position sensor 52 can be viewed simultaneously. Commercially available FIB machining devices contain a function to measure the distance between two points on the screen so that the distance between the specimen 51 and the light position sensor 52 built into the specimen holder can be precisely measured as the distance from Sx, Sy. The accuracy of a distance measured between two points depends on the magnification scale used during observation. At a magnification scale of 100 times for example, one pixel on the screen is approximately 3.6 microns; and at a magnification scale of 300 times, one pixel on the screen is approximately 1.2 microns. The movement distance from the center of the light position sensor 52 to the specimen 51 is in this way determined by S_{X} and S_{Y}. When using a four-segment light position sensor as the light position sensor device, and the four output signals from the four-segment light position sensor 53 are set respectively as I_{UR}, I_{UL}, I_{LR} and I_{LL} as shown in FIG. 5A, then the light spot positions D_{X}, D_{Y} from the center of the light position sensor 53 are given by the following equation as follows:

D_{X}=(I_{UR}−I_{UL}+I_{LR}−I_{LL})/(I_{UR}+I_{UL}+I_{LR}+I_{LL})×K_{X}

D_{Y}=(I_{UR}+I_{UL}−I_{LR}−I_{LL})/(I_{UR}+I_{UL}+I_{LR}+I_{LL})×K_{Y}

Here, K_{X} and K_{Y} are a factor of proportionality. If the fine-motion signals M_{X} and M_{Y} of the optical fiber are then set so that:

M_{X}=S_{X}−D_{X}

M_{Y}=S_{Y}−D_{Y}

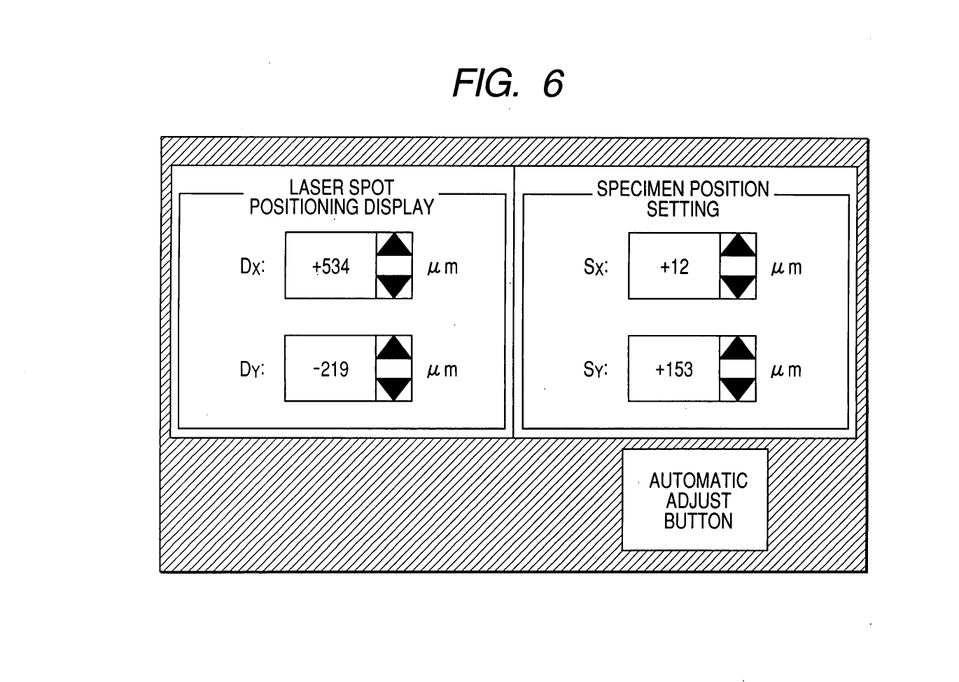

Then, the light spot is irradiated onto the specimen position. FIG. 5B shows these signal relations as a diagram, where each signal is shown converted by an equivalent signal processor. An operation panel is prepared here as shown in FIG. 6, and the center positions D_{X} and D_{Y} are calculated from the I_{UR}, I_{UL}, I_{LR}, and I_{LL} signals from the four-segment light position sensor, and displayed on the screen. The auto adjust button is pressed to adjust the light spot center to the center of the four-segment light position sensor. This auto adjust button automatically executes the following procedure. Namely, by taking the signal differential and inputting it as the drive signals Mₓ and M_{y} for the fine positioning mechanism in the X-direction and Y-direction of the optical fiber, the center of the light spot is adjusted to the center of the four-segment light position sensor. Next, by inputting a signal for a pre-measured distance between the specimen and the four-segment light position sensor as a drive voltage for the fine positioning mechanism in the optical fiber's X-direction and Y-direction, the light spot can be automatically adjusted to irradiate onto the center of the specimen.

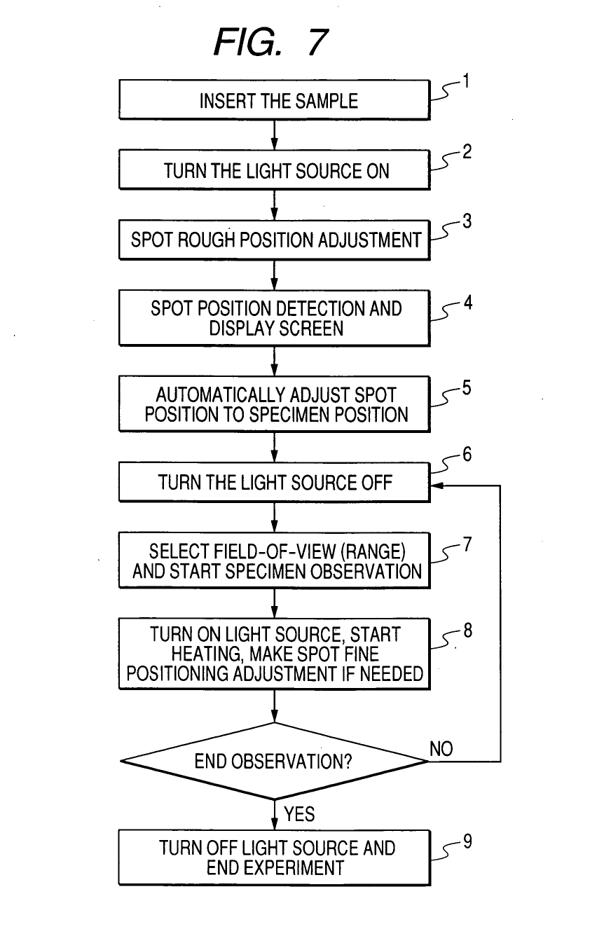

FIG. 7 is a flow chart showing the specimen observation procedure in the first embodiment. The specimen is first inserted into the electron microscope and guided into the specimen chamber. Here, the light source is turned on and the coarse adjustment and fine adjustment for the above spot position are made. The light output can here be reduced to a small level if the specimen does not need to be actually heated for this position adjustment. After the light source is turned off, the specimen is observed in the electron microscope and the desired section for observation then determined. After deciding on the observation section, the light source is turned on, and the specimen is then observed while heated by the focused light spot. Fine adjustments can of course be made to the light spot position while observing changes in the specimen. After completing observation of a desired section, and then observing other sections, the light source may be turned off if necessary so as not to heat the specimen the field-of-view selected and then the light source turned on again and this process repeated for each new specimen section. The field-of-view can of course also be changed while the light source is still on and the specimen is heated. After all observation is complete, the light source is turned off and the experiment ends. The size of the focused light spot depends on the light wavelength and the design of the converging lens but is equivalent to the wavelength.

In this embodiment, the heated section is an area of several to several dozen microns where the light is focused and the time required to raise the temperature is extremely short, and the temperature can be raised instantaneously by increasing the light intensity. The laser utilized in this embodiment may be any laser provided that light can be transmitted through the optical fiber without losses and for example a laser such as the typical Nd-YAG laser may be used. Moreover, in this embodiment the light is converged by a lens so that a lower output laser may be usable according to the type of material, and the laser need not be the continuous oscillation type and may utilize a pulse type light source.

Effects on the electron beam due to light are small enough to be ignored compared to effects from the electron beam and the invention also renders the advantage that there is no problem of contamination occurring due to the focused electron beam. Though already mentioned, the heated section can be adjusted in the vicinity of the observation section rather than the observation section itself. In that case, the temperature in the observation section is determined by the heat conduction from the section where the light is irradiated.

### Second Embodiment

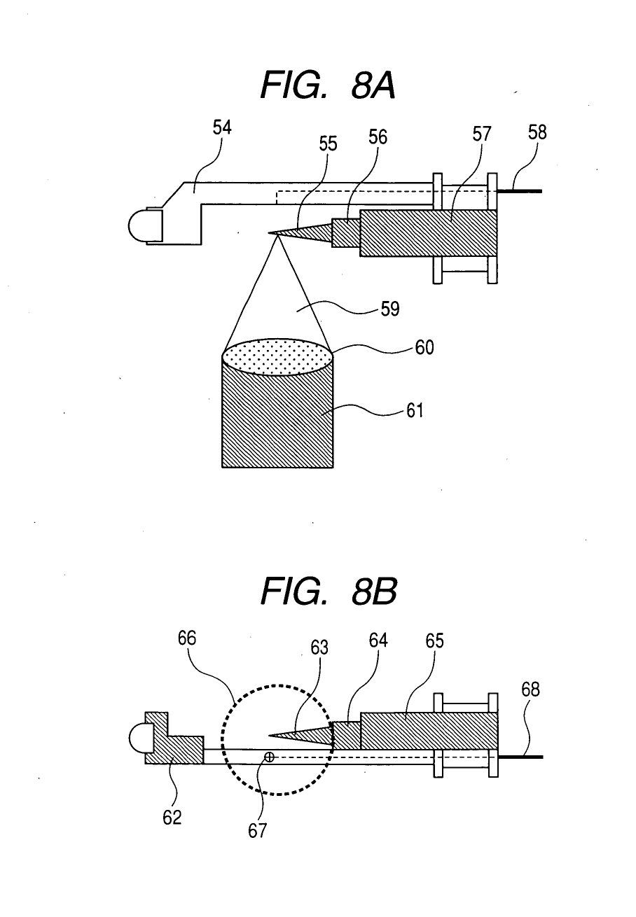

In this embodiment, an electron microscope using a specimen holder different from the specimen holder of the first embodiment is described. The overall structure of the device is identical to the device shown in FIG. 1. FIG. 8 shows the holder of the second embodiment of this invention ideal for holding pillar-shaped specimens and that does not utilize specimens mounted on a mesh as in the first embodiment. A specimen in a pillar shape offers the advantage that the specimen can be tilted to allow three-dimensional observation. FIG. 8A shows the specimen holder 54 and the specimen 55 as seen from above. The drawing is shown along the direction the electron beam progresses. The specimen 55 here is machined into a pillar shape to allow the electron beam to transmit through the tip of the specimen piece 56 clamped in the support stand 57. The specimen 55 is fabricated by an apparatus for machining TEM or STEM specimens such as by using an FIB machining apparatus. A spot of focused light 59 focused by a lens 60 formed on the tip of the optical fiber 61 irradiates the specimen 55 to heat it the same as in the first embodiment. A light sensor not shown in the drawing is positioned above the tip of the specimen 55 shown in the figure. The signal from the light sensor is output on the signal line 58.

FIG. 8B on the other hand, is a view of the specimen holder 62 and the specimen 63 as seen from the side. In FIG. 8B, a light position sensor 67 required to adjust the position of the light spot is a section on the specimen holder 62, and is positioned in the vicinity of the pillar specimen 63. The dotted circle in the figure shows the relative position of the lens 60 and the pillar specimen 63 on the cross section of optical fiber 61. The cross section of the lens 60 and the optical fiber 61 is actually positioned on the nearer side of pillar specimen 63 as seen in the figure, and light is irradiated towards the inside. The signal from the light sensor is output along the signal line 68 the same as in FIG. 8A. The procedure for adjusting the position is the same as in the first embodiment. The distance between the observation section on the specimen 63 and the light position sensor 67 can in this case also be measured precisely when FIB machining the specimen on a thin film.

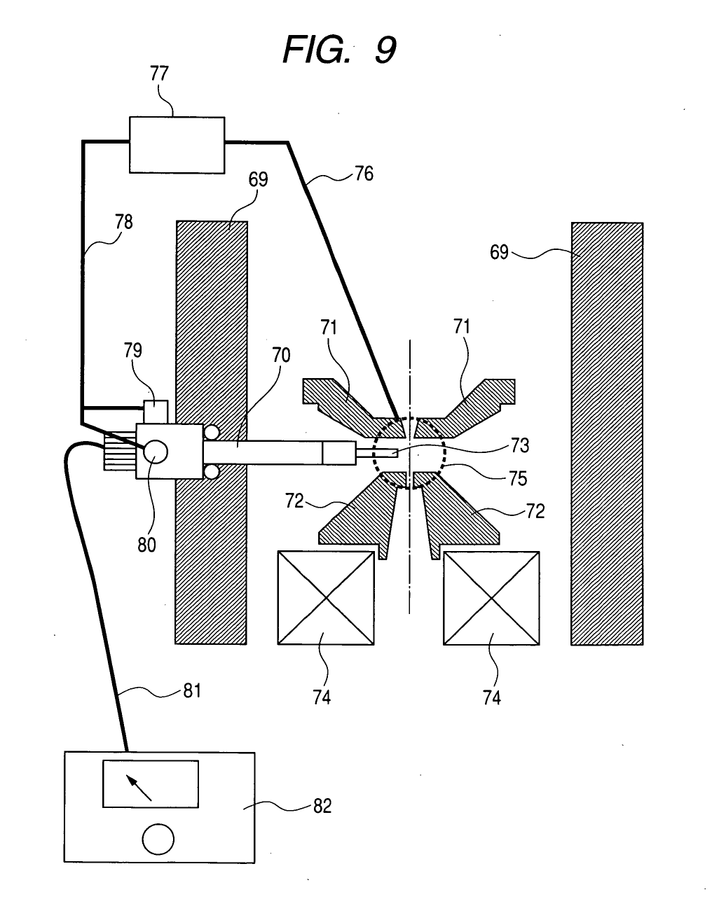

FIG. 9 is a pictorial diagram showing an example of the fine positioning mechanism and the method for guiding the optical fiber used in the first and the second embodiments. The fine positioning mechanism shown in this figure is an element making up a portion of the structure of a light beam mechanism 4 in FIG. 1. This fine positioning mechanism is installed at a position corresponding to the specimen holder on the outer wall of the vacuum partition for the electron microscope shown in FIG. 1. The specimen holder is here inserted perpendicularly, in the gap between the magnet 71 above the objective lens and the magnet 72 below the objective lens. The cross section 75 of the specimen holder is shown by the dotted lines in this figure. This gap must be as small as possible in order to obtain high spatial resolution because electrical current must flow in the coils 74 to generate a magnetic field concentrated in the specimen the optical fiber in this invention can be utilized as it is sufficiently smaller than the gap. The holder 70 supports the optical fiber in this invention, and the tip 73 of the holder 70 is placed in the vicinity of the specimen. The holder 70 of the optical fiber contains a fine positioning mechanism 80 for moving the optical fiber horizontally and a fine positioning mechanism 79 for moving the optical fiber vertically. These fine positioning mechanisms can improve the operability if each include two types of fine positioning mechanisms, namely for rough and fine movement. The signal output from the light position sensor built into the specimen holder connects via the signal line 76 to the control device 77. This signal output is then converted for fine movement control and then input to these fine positioning mechanisms 79, 80 by way of the signal line 78. The control device 77 in this figure corresponds to the control device 6 in FIG. 1. The signal line 76 and the signal line 78 in this figure correspond to the signal line 5 and the signal line 7 in FIG. 1. Information on the distance between the light position sensor and the thin film machined section of the specimen is stored in the memory means within the control device 77. This distance information is retrieved when the control device 77 is positioning the light spot. Light used for heating is conducted from the light source 82 via the cable 81 containing an internal optical fiber, to the fiber holder 70. In order to avoid effects on the electron microscope focusing due to static charges caused by electron ray irradiation from the optical fiber and the tip of that fiber, vapor deposition of conductive materials such as metallic thin films of gold (Au) are preferably avoided as much as possible.

What is claimed is:

1. An electron microscope for irradiating or scanning an electron beam onto a specimen, detecting the electron beam transmitting through the specimen and making an image, the electron microscope comprising:
a specimen holder supporting a specimen and a specimen stand for holding the specimen on one side surface, and a space on the other side surface; and
a focus light ray unit for heating the specimen or the specimen stand by irradiating focused light from the vicinity of that side surface.

2. The electron microscope according to claim 1,
wherein the specimen holder includes a light position sensor on one side surface, and
wherein a fine positioning mechanism adjusts the irradiation position horizontally or vertically towards the specimen by utilizing the output from the light position sensor.

3. The electron microscope according to claim 1, wherein the focus light ray unit utilizes laser light as the focused light.

4. The electron microscope according to claim 3, wherein the focus light ray unit includes an optical fiber for transmitting the laser light; and a lens installed onto the tip of the optical fiber.

5. The electron microscope according to claim 4, wherein a thin metallic film is vapor-deposited onto the lens and the tip of the optical fiber.

6. A transmission electron microscope for irradiating or scanning an electron beam onto a specimen, detecting the electron beam transmitting through the specimen and making an image, the transmission electron microscope comprising:
a specimen piece holder supporting a specimen stand for holding the specimen on one side surface;
a focus light ray unit for heating the specimen by irradiating focused light from the vicinity of the side surface of the specimen stand holding the specimen;
a light position sensor formed on one side surface of the specimen piece holder; and
a fine positioning mechanism for adjusting the irradiation position of the focused light towards the specimen by utilizing the output from the light position sensor.

7. The transmission electron microscope according to claim 6, wherein the fine positioning mechanism moves the focused light in fine movements horizontally and vertically on the side surface of the specimen stand.

8. The transmission electron microscope according to claim 6, wherein the focus light ray unit utilizes laser light as the focused light.

9. The transmission electron microscope according to claim 8, wherein the focus light ray unit comprises an optical fiber for transmitting the laser light, and a lens installed onto the tip of the optical fiber.

10. The transmission electron microscope according to claim 9, wherein a thin metallic film is vapor-deposited onto the lens and the tip of the optical fiber.
